(19) United States
(12) Patent Application Publication
(10) Pub. No.: US 2016/0247027 A1
(43) Pub. Date: Aug. 25, 2016

(54) Electronic door peephole system and monitoring method thereof

(71) Applicants: Alphan Tsoi, Monterey Park, CA (US); Stuart Whang, Monterey Park, CA (US)

(72) Inventors: Alphan Tsoi, Monterey Park, CA (US); Stuart Whang, Monterey Park, CA (US)

(21) Appl. No.: 14/544,840

(22) Filed: Feb. 24, 2015

(51) Int. Cl. G06K 9/00; H04L 12/24; H04L 29/08; H04N 7/18; H04N 5/225

(52) U.S. Cl. CPC G06K 9/00771; H04N 7/183; H04N 5/2252; H04L 67/125; H04L 41/22

(57) ABSTRACT

An electronic door peephole system for a peephole of a door includes a viewing unit and a monitoring module. The viewing unit includes an image capturer adapted for installing into the peephole of the door to capture an image at an exterior area to the door and a wireless controller operatively linked to the image capturer for wirelessly transmitting the image captured by the image capturer. The monitoring module is wirelessly linked to the wireless controller for processing the image transmitted therefrom so as to visually display the image away from the door. Therefore, a viewer is able to watch the visitor or the event outside the house away from the door for safety purpose.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to an apparatus for viewing through a door, and more particularly to an electronic door peephole system and a monitoring method thereof, which allows a viewer inside the security of seeing outside without approaching the door.

2. Description of Related Arts

A peephole is a small opening at a door such that a door lens can be installed at the peephole for enabling a viewer to watch the visitor or the event outside the house without opening the door. Even though this peephole enables the viewer to see who's outside the door, its physical location has several drawbacks. Due to the size of the peephole, the viewing angle of the door lens will be limited. Even though a wide-angle door lens is used, the door lens is too small to provide the viewer with sufficient vision field. This door lens can only allow the viewer to view but not capture any image at the other side of the door. More importantly, the viewer must approach to one side of the door for observation through the peephole, an intruder at the other side of the door may hurt the viewer easily by breaking down the door or even shooting through the door.

An improved device is a digital viewer to be installed into the peephole of the door, wherein the digital viewer comprises a camera lens for capturing an image outside the house and a screen display located at an interior side of the door for displaying the image. This digital viewer can solve the one of mentioned problem of providing a sufficient vision field. However, the digital viewer is incapable of saving the image in digital form due to the insufficient storage capacity. The viewer must come close to the screen display to view the image captured by camera lens. In addition, the digital viewer requires relatively large electrical power to keep the activation of the digital viewer. Otherwise, the digital viewer must be installed to electrically connect with a power outlet.

### SUMMARY OF THE PRESENT INVENTION

The invention is advantageous in that it provides an electronic door peephole system and a monitoring method thereof, which allows a viewer inside the security of seeing outside without approaching the door.

Another advantage of the invention is to an electronic door peephole system and a monitoring method thereof, which comprises a viewing unit incorporated with any existing peephole of the door to see the visitor or the event outside the house in distance.

Another advantage of the invention is to an electronic door peephole system and a monitoring method thereof, wherein the viewing unit comprises an image capturer at a peephole of the door for capturing an image at an exterior side of the door and a wireless controller transmitting the image to an electronic device in a wireless manner. Therefore, the viewer is able to view the image at the electronic device away from the door instead of come closely to the door.

Another advantage of the invention is to an electronic door peephole system and a monitoring method thereof, wherein the viewing unit is a self-powered unit, such that the installation of the viewing unit is simple and easy without any electrical wiring structure to the power outlet.

Another advantage of the invention is to an electronic door peephole system and a monitoring method thereof, wherein the image capturer is activated to capture the image by an activation device which can be a door bell button or a motion sensor.

Another advantage of the invention is to an electronic door peephole system and a monitoring method thereof, wherein the image capturer can be wirelessly controlled by the electronic device to save and record therein.

Another advantage of the invention is to an electronic door peephole system and a monitoring method thereof, wherein the image capturer is automatically returned to its standby mode after a period of time or by the electronic device so as to save the power consumption of the image capturer.

Another advantage of the invention is to an electronic door peephole system and a monitoring method thereof, wherein the electronic device can be a portable personal electronic device, such as a Smartphone or a tablet, by simply installing a monitoring module as a software thereinto, or can be a portable screen device with a built-in display screen and monitoring module. In particular, the monitoring module not only processes the image to be displayed on a screen of the portable personal electronic device and/or the portable screen device but also wirelessly control an operation of the image capturer.

Another advantage of the invention is to an electronic door peephole system and a monitoring method thereof, wherein the viewer is able to see the visitor via the captured image and at the same time to voice-communicate with a visitor via an intercommunication unit by using the electronic device.

Another advantage of the invention is to an electronic door peephole system and a monitoring method thereof, which does not require to alter the original structural design of the door, so as to minimize the installation cost of the electronic door peephole system incorporating with the door with the peephole thereat.

Another advantage of the invention is to an electronic door peephole system and a monitoring method thereof, wherein no expensive or complicated structure is required to employ in the present invention in order to achieve the above mentioned objects. Therefore, the present invention successfully provides an economic and efficient solution for providing a simple and safe configuration for the viewer to monitor the exterior area of the door even though the viewer is not at home.

Additional advantages and features of the invention will become apparent from the description which follows, and may be realized by means of the instrumentalities and combinations particular point out in the appended claims.

According to the present invention, the foregoing and other objects and advantages are attained by an electronic door peephole system for a peephole of a door, comprising a viewing unit and a monitoring module.

The viewing unit comprises an image capturer adapted for installing into the peephole of the door to capture an image at an exterior area to the door, and a wireless controller operatively linked to the image capturer for wirelessly transmitting the image captured by the image capturer to the monitoring module.

The monitoring module is wirelessly linked to the wireless controller for processing the image transmitted therefrom so as to visually display the image away from the door. Therefore, a viewer is able to watch the visitor or the event outside the house away from the door for safety purpose.

In accordance with another aspect of the invention, the present invention comprises a method of monitoring an exterior area to a door having a peephole, which comprises the following steps.

(1) Capture an image at the exterior area to the door via an image capturer installed into the peephole of the door.

(2) Wirelessly transmit the image captured by the image capturer via a wireless controller to a monitoring module.

(3) Process the image by the monitoring module to visually display the image away from the door.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an electronic door peephole system for a peephole of a door according to a preferred embodiment of the present invention.

FIG. 2 is a sectional view of a viewing unit of the electronic door peephole system according to the above preferred embodiment of the present invention.

FIG. 3 is a block diagram of the electronic door peephole system according to the above preferred embodiment of the present invention.

FIG. 4 is a flow diagram illustrating the monitoring method according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

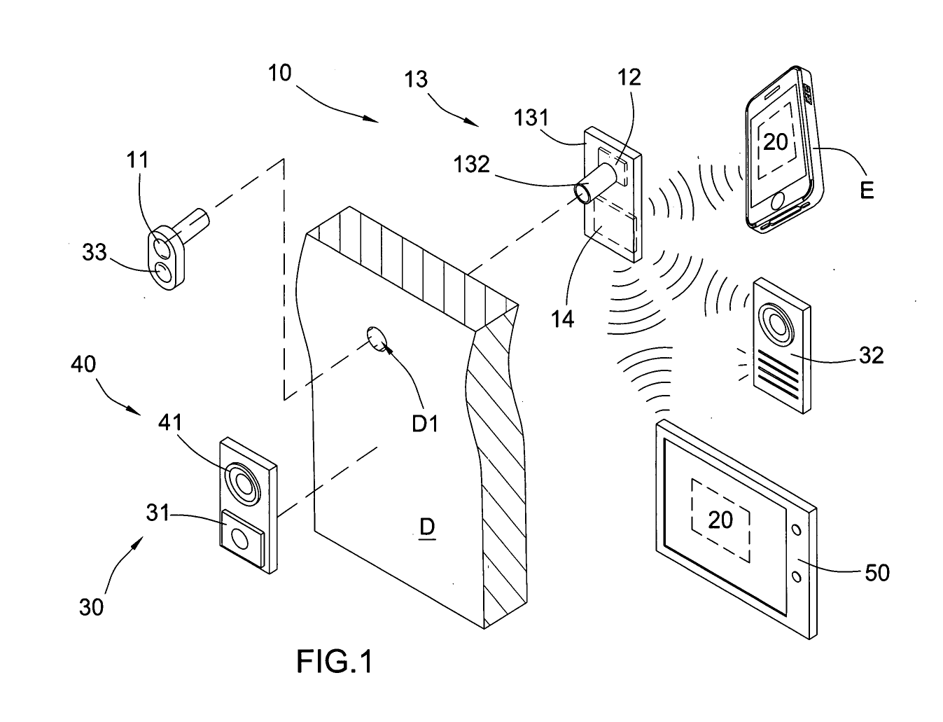

Referring to FIGS. 1 to 3 of the drawings, an electronic door peephole system according to a preferred embodiment of the present invention is illustrated, wherein the electronic door peephole system of the present invention is arranged for incorporating with a door D having a peephole D1. According to the preferred embodiment, the electronic door peephole system comprises a viewing unit 10 and a monitoring module 20.

The viewing unit 10 comprises an image capturer 11 adapted for installing into the peephole D1 of the door D to capture an image at the exterior area to the door D. Accordingly, the image capturer 11 can be camera having a size and shape to be installed within the peephole D1 of the door, wherein the image capturer 11, having a high resolution, can capture a still image at a predetermined time frame or a video. In particular, the image captured by the image capturer 11 is a live image. Preferably, the image capturer 11 comprises a lens module and an image controlling circuit for obtaining the digital image.

The viewing unit 10 further comprises a wireless controller 12 operatively linked to the image capturer 11 for wirelessly transmitting the image captured by the image capturer 11 to the monitoring module 20. Accordingly, the wireless controller 12 is wirelessly connected to the monitoring module 20 via a first wireless link, such as Wi-Fi, “Bluetooth”, Infrared (IR), or Radio frequency (RF). In particular, once the image is captured by the image capturer 11, the wireless controller 12 will instantly send the image to the monitoring module 20. In other words, the wireless controller 12 will not process or convert the image from the image capturer 11.

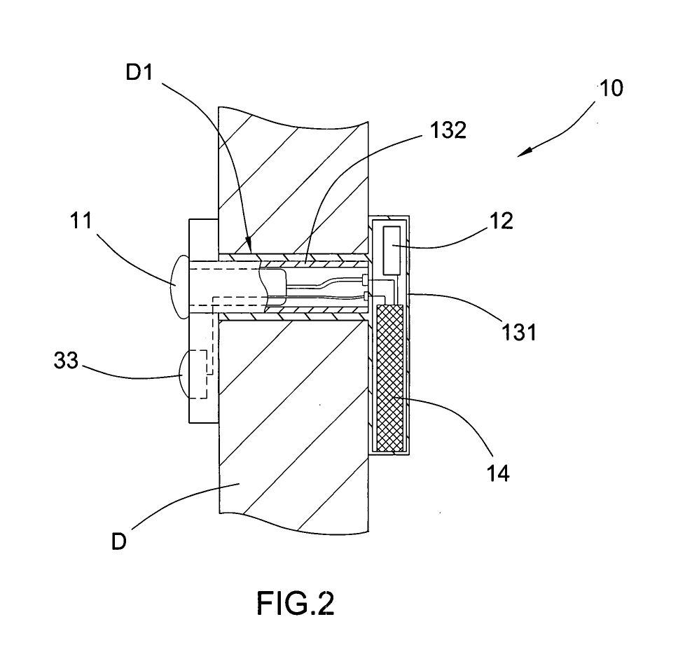

As shown in FIGS. 1 and 2, the viewing unit 10 further comprises a casing unit 13 for the image capturer 11 and the wireless controller 12. According to the preferred embodiment, the casing unit 13 comprises a supporting casing 131 adapted for mounting at an interior side of the door D to receive the wireless controller 12, and a housing 132 extended from the supporting casing 131 for mounting at the peephole D1 of the door D so as to receive the image capturer 11 in the housing 132 within the peephole D1.

The viewing unit 10 further comprises a battery unit 14 received in the supporting casing 131 of the casing unit 13 and electrically linked to the image capturer 11 and the wireless controller 12. Accordingly, the viewing unit 10 is a self-powered unit, wherein the battery unit 14 can be a rechargeable battery cell or a battery compartment for receiving a replaceable battery or a rechargeable battery.

The monitoring module 20 is wirelessly linked to the wireless controller 12 for processing the image transmitted therefrom so as to visually display the image away from the door D. In particular, the monitoring module 20 is arranged to convert the successive images from the image capturer 11 into continuous dynamic images after transmitting from the wireless controller 12. Therefore, all the image processes and conversion will execute by the monitoring module 20.

According to the preferred embodiment, the monitoring module 20 is embodied as a software or “App” which comprises a control processing unit 21 adapted for installing into a portable personal electronic device E, such as a smart phone, a tablet, or a portable computer, such that the control processing unit 21 is executed by the portable personal electronic device. The control processing unit 21 installed into the portable personal electronic device not only processes the image sent from the wireless controller 12 to be displayed on a screen of the portable personal electronic device E but also wirelessly controls an operation of the image capturer 11 to capture the image. Preferably, a wireless connection module is built-in with the portable personal electronic device E to wirelessly link to the wireless controller 12 via the control processing unit 21 of the monitoring module 20.

The control processing unit 21 of the monitoring module 20 is executed to process the image and to provide a user interface that allows the viewer to set and control the viewing unit 10. In particular, the user interface provides a connection setting to wirelessly connect the monitoring module 20 with the wireless controller 12, and an operational setting to wireless operate the image capturer 11. In other words, once the wireless connection between the monitoring module 20 and the viewing unit 10 is established, the control processing unit 21 can control the image capturer 11 to capture the image and save the images in the storage of the portable personal electronic device E. For example, the video from the image capturer 11 can be wirelessly sent to the monitoring module 20 and saved in the portable personal electronic device E.

The monitoring module 20 further comprises an alert unit 22 for automatically contacting the nearest police station or for automatically calling an emergency telephone number, such as 911. Therefore, in case of emergency, the viewer is able to instantly call for help instantly without approaching the door. For example, an icon of the alert unit 22 is shown on the display of the portable personal electronic device E, such that after viewing the image from the image capturer 11, the viewer is able to call the police instantly by pressing or touch the icon of the alert unit 22.

As a result, the viewer is able to view the image away from the door, such as in the bedroom. Even though the viewer is not at home, the viewer is still able to view the image from the image capturer 11 via the wireless connection between the monitoring module 20 and the viewing unit 10.

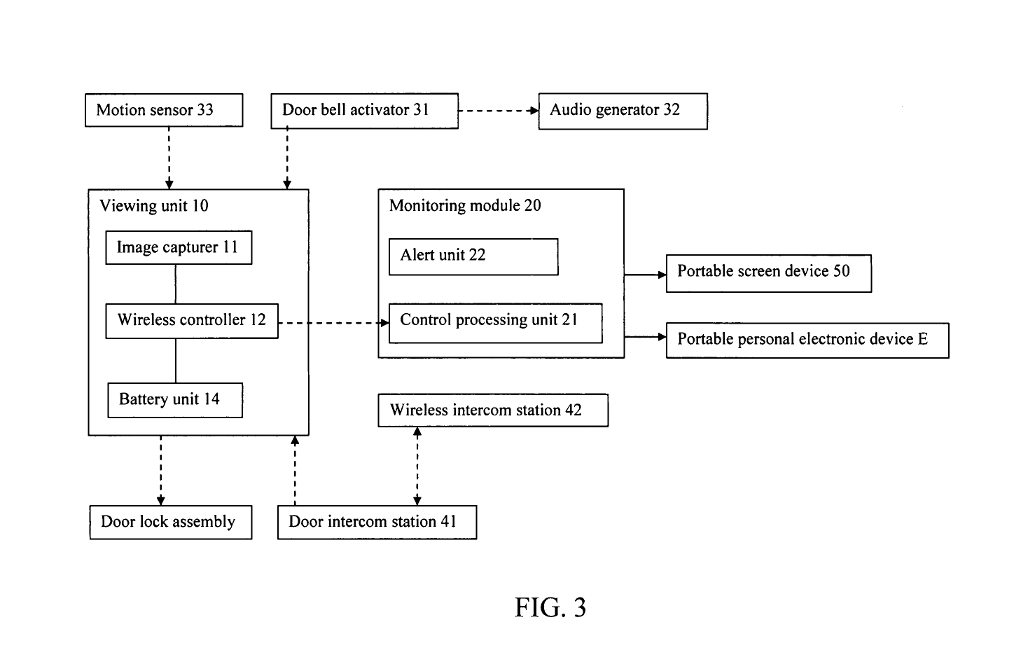

As shown in FIGS. 1 and 3, the electronic door peephole system further comprises an activation unit 30 wirelessly linked to the wireless controller 12 to activate the image capturer 11 for capturing the image and to activate the monitoring module 20 for receiving the image from the wireless controller 12. Accordingly, the viewing unit 10 is configured between an operation mode and a standby mode. At the operation mode, the image capturer 11 will capture the image and the image will be wirelessly sent to the monitoring module 20. At the standby mode, the image capturer 11 and the wireless controller 12 are switched off to save the power consumption thereof. The activation unit 30 is arranged to switch the viewing unit 10 from the standby mode to the operation mode. It is worth mentioning that the viewing unit 10 is automatically returned to its standby mode after a period of time or by the monitoring module 20 installed into the portable personal electronic device E so as to save the power consumption of the viewing unit 10.

According to the preferred embodiment, the activation unit 30 comprises a door bell activator 31 wirelessly linked to the wireless controller 12 and an audio generator 32 wirelessly linked to the door bell activator 31 for generating an audio notifying signal. Accordingly, the door bell activator 31 is located at the exterior area of the door to wireless link to the wireless controller 12 via a second wireless link, such as “Bluetooth”, Infrared (IR), or Radio frequency (RF). In addition, the audio generator 32 is located within a building and is wirelessly linked to the door bell activator 31 via the second wireless link.

When the door bell activator 31 is actuated, by a pressing or touching, the audio generator 32 is activated for generating the audio notifying signal. At the same time, the viewing unit 10 is activated from the standby mode to the operation mode, such that the image capturer 11 is activated to capture the image and the wireless controller 12 is activated to wirelessly send the image to the monitoring module 20. It is worth mentioning that when the door bell activator 31 is actuated to activate the wireless controller 12 for sending the image, the control processing unit 21 is automatically activated to generate a notifying signal to notify the image sent from wireless controller 12. Therefore, the viewer is able to view the image even though he or she is not in the building.

Accordingly, the door bell activator 31 comprises a battery compartment for receiving a battery therein such that the door bell activator 31 can form a self-powered unit to be installed at any desired location of the exterior area of the door D. The audio generator 32 can be incorporated with a battery or can be directly plugged into any power outlet in the building to wireless connect with the door bell activator 31.

Alternatively, the activation unit 30 comprises a motion sensor 33 which is operatively linked to the wireless controller 12, wherein the motion sensor 33 is triggered, in response to a presence of an object at the exterior area to the door D, to activate the image capturer 11 and the monitoring module 20 at the same time. Accordingly, the motion sensor 33 is preferably located at the exterior side of the door D adjacent to the peephole D1, wherein the motion sensor 33 is supported by the housing 132 of the casing unit 13. The activation of the motion sensor 33 is similar to that of the door bell activator 31 that when the motion sensor 33 detects a presence of the object, such as a visitor, within the exterior area of the door D, the viewing unit 10 is activated from the standby mode to the operation mode, such that the image capturer 11 is activated to capture the image and the wireless controller 12 is activated to wirelessly send the image to the monitoring module 20.

As shown in FIGS. 1 and 3, the electronic door peephole system further comprises a two-way intercommunication unit 40 for allowing the viewer to voice-communicate with the visitor. Accordingly, the intercommunication unit 40 comprises a door intercom station 41 operatively linked to the wireless controller 12 and a wireless intercom station 42 operatively linked to the monitoring module 20 for voice-communicating the door intercom station 41.

Preferably, the door intercom station 41 is operatively linked to the door bell activator 31, such that when the door bell activator 31 is actuated, the door intercom station 41 is activated to transmit a voice signal between the door intercom station 41 and the wireless intercom station 42.

It is worth mentioning that the wireless intercom station 42 can be built-in with the control processing unit 21, wherein the viewer is able to use the portable personal electronic device E to transmit the voice signal to the door intercom station 41. In other words, the viewer is able to view the image of the visitor on the portable personal electronic device E and to talk to the visitor through the portable personal electronic device E.

For example, when the visitor actuates the door bell activator 31 or is detected by the motion sensor 33 while the viewer is driving back home, the image of the visitor will be captured by the image capturer 11 and will be wirelessly sent to the portable personal electronic device E via the control processing unit 21 of the monitoring module 20. Then, the viewer is able to view the image of the visitor through the portable personal electronic device E and talk to the visitor via the portable personal electronic device E instantly. If the intruder is located in front of door, the viewer is able to view the image of the intruder without coming close to the door and save the image thereof in the portable personal electronic device E. The viewer is able to call the police right the way by the portable personal electronic device E via the alert unit 22 of the monitoring module 20.

FIGS. 1 and 3 illustrates an alternative mode of the electronic door peephole system which comprises a portable screen device 50, wherein the control processing unit 21 of the monitoring module 20 is built-in with the portable screen device 50, such that the viewer is able to use the portable screen device 50 to process the image sent from the wireless controller 12 to be displayed on a screen of the portable screen device 50 and to wirelessly control an operation of the image capturer 11 to capture the image. In addition, the portable screen device 50 can also save the images from the image capturer 11. It is worth mentioning that the alert unit 22, the audio generator 32, and the wireless intercom station 42 are also provided in the portable screen device 50, such that the portable screen device 50 forms an all-in-one unit to wirelessly link to the viewing unit 10. Accordingly, the wireless connection module is built-in with the portable screen device 50 to wirelessly link to the wireless controller 12 via the control processing unit 21 of the monitoring module 20.

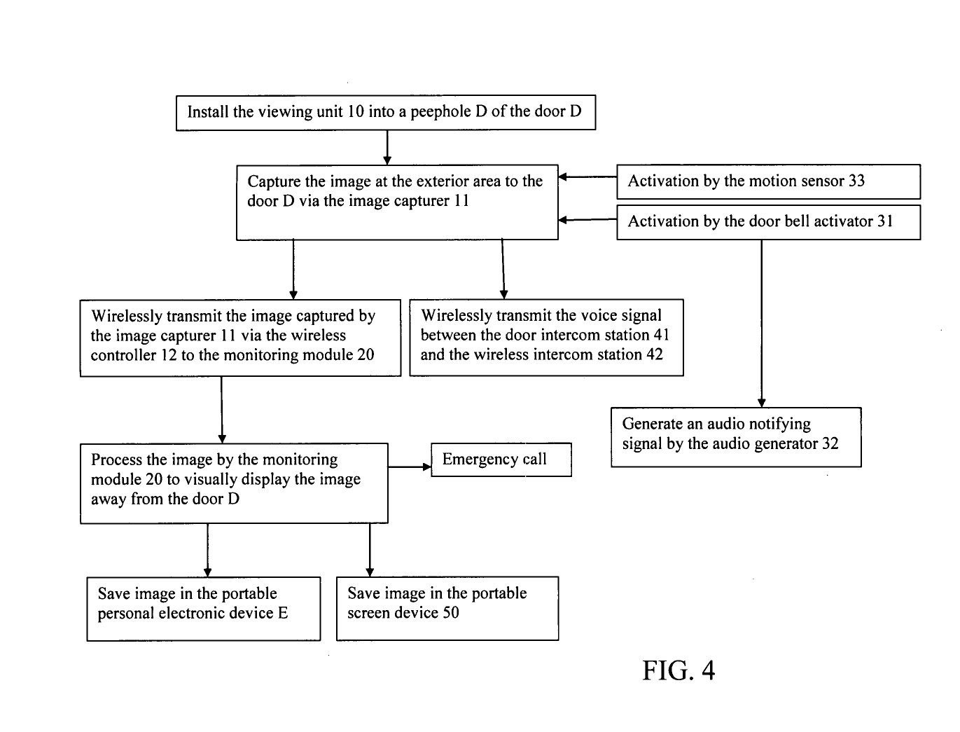

As shown in FIG. 4, the present invention further provides a method of monitoring the exterior area to the door D having the peephole D thereat, wherein the method comprises the following steps.

(1) Capture the image at the exterior area to the door D via the image capturer 11 installed into the peephole D1 of the door D. Accordingly, the image capturer 11 is activated from the standby mode to the operation mode via the activation unit 30. In particular, the door bell activator 31 is actuated for activating the image capturer 11 for capturing the image and activating the monitoring module 20 for receiving the image from the wireless controller 12 at the same time. Alternatively, the image capturer 11 and the monitoring module 20 are activated at the same time by the motion sensor 33.

It is worth mentioning that the audio generator 32 is also activated for generating the audio notifying signal when the door bell activator 31 is actuated.

(2) Wirelessly transmit the image captured by the image capturer 11 via the wireless controller 12 to the monitoring module 20. Once the image is captured by the image capturer 11, the image will be automatically sent from the wireless controller 12 to the monitoring module 20 via the first wireless link.

(3) Process the image by the monitoring module 20 to visually display the image away from the door D. Accordingly, when the monitoring module 20 is installed into the portable personal electronic device E, the viewer is able to use the portable personal electronic E to process the image sent from the wireless controller 12 to be displayed on the screen of the portable personal electronic device E and to wirelessly control an operation of the image capturer 11 to capture the image. In addition, the images can be saved and stored in the portable personal electronic device E. Likewise, when the portable screen device 50 is provided to pre-install the monitoring module 20 thereinto, the viewer is able to use the portable screen device 50 to process the image sent from the wireless controller 12 to be displayed on the screen of the portable screen device 50 and to wirelessly control an operation of the image capturer 11 to capture the image. In addition, the images can be saved and stored in the portable screen device 50.

At the same time, the voice signal can be wirelessly transmitted between the door intercom station 41 and the wireless intercom station 42 when the image capturer 11 is activated by the actuation of the door bell activator 31.

Accordingly, when a mailman delivers a package while the viewer is not at home, the viewer is able to talk to the mailman where he or she should drop the package via the electronic door peephole system of the present invention. If a thief tries to steal the package in front of the door D, the viewing unit 10 is activated by the motion sensor 33, such that the image of the thief will be captured and the viewer is able to instantly notify there is a thief right in front of the door D.

It is worth mentioning that the viewing unit 10 can be wirelessly connected to two or more monitoring modules 20 which are installed into different portable personal electronic devices E and/or the portable screen devices 50. Therefore, the image from the viewing unit 10 will be wirelessly sent to different portable personal electronic devices E and/or the portable screen devices 50 at the same time. It is worth mentioning that after receiving the image, the portable personal electronic device E and/or the portable screen device 50 can wirelessly send the received image to other electronic devices. For example, when the visitor is looking for a family member of the viewer, who is not at home, the viewer is able to instantly send the image of the visitor to the family member via the portable personal electronic device E and/or the portable screen device 50 for confirmation.

In addition, when an electronic door lock assembly is installed into the door D, the viewing unit 10 can be operatively linked to the door lock assembly by wire or wirelessly, such that the monitoring module 20 can control the locking/unlocking operation of the electronic door lock assembly via the portable personal electronic device E and/or the portable screen device 50.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An electronic door peephole system for a peephole of a door, comprising:
a viewing unit which comprises:
an image capturer adapted for installing into the peephole of the door to capture an image at an exterior area to the door; and
a wireless controller operatively linked to said image capturer for wirelessly transmitting said image captured by said image capturer; and
a monitoring module wirelessly linked to said wireless controller for processing said image transmitted therefrom so as to visually display said image away from the door.

2. The electronic door peephole system, as recited in claim 1, wherein said viewing unit further comprises a supporting casing adapted for mounting at an interior side of the door to receive said wireless controller, and a housing extended from said supporting casing for mounting at the peephole of the door so as to receive said image capturer in said housing within the peephole.

3. The electronic door peephole system, as recited in claim 1, wherein said monitoring module comprises a control processing unit adapted for installing into a portable personal electronic device to not only process said image sent from said wireless controller to be displayed on a screen of the portable personal electronic device but also wirelessly control an operation of said image capturer to capture said image.

4. The electronic door peephole system, as recited in claim 2, wherein said monitoring module comprises a control processing unit adapted for installing into a portable personal electronic device to not only process said image sent from said wireless controller to be displayed on a screen of the portable personal electronic device but also wirelessly control an operation of said image capturer to capture said image.

5. The electronic door peephole system, as recited in claim 1, wherein said monitoring module comprises a display screen and a control processing unit operatively linked to said display screen to not only process said image sent from said wireless controller to be displayed on said display screen but also wirelessly control an operation of said image capturer to capture said image.

6. The electronic door peephole system, as recited in claim 2, wherein said monitoring module comprises a display screen and a control processing unit operatively linked to said display screen to not only process said image sent from said wireless controller to be displayed on said display screen but also wirelessly control an operation of said image capturer to capture said image.

7. The electronic door peephole system, as recited in claim 4, further comprising an activation unit wirelessly linked to said wireless controller to activate said image capturer for capturing said image and to activate said monitoring module for receiving said image from said wireless controller.

8. The electronic door peephole system, as recited in claim 6, further comprising an activation unit wirelessly linked to said wireless controller to activate said image capturer for capturing said image and to activate said monitoring module for receiving said image from said wireless controller.

9. The electronic door peephole system, as recited in claim 7, wherein said activation unit comprises a door bell activator wirelessly linked to said wireless controller and an audio generator wirelessly linked to said door bell activator for generating an audio notifying signal, in such a manner that said door bell activator is actuated to activate said image capturer, said monitoring module, and said audio generator at the same time.

10. The electronic door peephole system, as recited in claim 8, wherein said activation unit comprises a door bell activator wirelessly linked to said wireless controller and an audio generator wirelessly linked to said door bell activator for generating an audio notifying signal, in such a manner that said door bell activator is actuated to activate said image capturer, said monitoring module, and said audio generator at the same time.

11. The electronic door peephole system, as recited in claim 7, wherein said activation unit comprises a motion sensor which is operatively linked to said wireless controller and is triggered, in response to a presence of an object at the exterior area to the door, to activate said image capturer and said monitoring module at the same time.

12. The electronic door peephole system, as recited in claim 8, wherein said activation unit comprises a motion sensor which is operatively linked to said wireless controller and is triggered, in response to a presence of an object at the exterior area to the door, to activate said image capturer and said monitoring module at the same time.

13. The electronic door peephole system, as recited in claim 4, further comprising a two-way intercommunication unit which comprises a door intercom station operatively linked to said wireless controller and a wireless intercom station operatively linked to said monitoring module for voice-communicating said door intercom station.

14. The electronic door peephole system, as recited in claim 6, further comprising a two-way intercommunication unit which comprises a door intercom station operatively linked to said wireless controller and a wireless intercom station operatively linked to said monitoring module for voice-communicating said door intercom station.

15. A method of monitoring an exterior area to a door having a peephole, comprising:
(a) capturing an image at the exterior area to the door via an image capturer installed into the peephole of the door;
(b) wirelessly transmitting said image captured by said image capturer via a wireless controller to a monitoring module; and
(c) processing said image by said monitoring module to visually display said image away from the door.

16. The method, as recited in claim 15, wherein the step (c) further comprises a step of installing said monitoring module into a portable personal electronic device to not only process said image sent from said wireless controller to be displayed on a screen of the portable personal electronic device but also wirelessly control an operation of said image capturer to capture said image.

17. The method, as recited in claim 16, wherein the step (c) further comprises a step of saving said image in the portable personal electronic device.

18. The method, as recited in claim 15, wherein the step (c) further comprises a step of providing a portable screen device with said monitoring module built-in therewith to not only process said image sent from said wireless controller to be displayed on a screen of said portable screen device but also wirelessly control an operation of said image capturer to capture said image.

19. The method, as recited in claim 16, wherein the step (c) further comprises a step of saving said image in the portable screen device.

20. The method, as recited in claim 15, wherein the step (a) further comprises a step of activating said image capturer for capturing said image and activating said monitoring module for receiving said image from said wireless controller at the same time by a door bell activator.

21. The method, as recited in claim 20, wherein the step (a) further comprises a step of generating an audio notifying signal by an audio generator when said door bell activator is actuated.

22. The method, as recited in claim 15, wherein the step (a) further comprises a step of activating said image capturer for capturing said image and activating said image capturer for capturing said image and to activate said monitoring module for receiving said image from said wireless controller at the same time by a motion sensor.

23. The method, as recited in claim 15, further comprising a step of transmitting a voice signal between a door intercom station and a wireless intercom station when said image capturer is activated, wherein said door station is located at the door to operatively link to said wireless controller and said wireless intercom station is operatively linked to said monitoring module.
